(19) United States
(12) Patent Application Publication
(10) Pub. No.: US 2009/0222321 A1
(43) Pub. Date: Sep. 3, 2009

(54) PREDICTION OF FUTURE POPULARITY OF QUERY TERMS

(75) Inventors: Ning Liu, Beijing (CN); Jun Yan, Beijing (CN); Zheng Chen, Beijing (CN); Jian Wang, Beijing (CN)

Correspondence Address: MICROSOFT CORPORATION, ONE MICROSOFT WAY, REDMOND, WA, 98052-6399, US

(73) Assignee: MICROSOFT CORPORATION, Redmond, WA (US)

(21) Appl. No.: 12/147,468

(22) Filed: Jun. 26, 2008

Related U.S. Application Data
(60) Provisional application No. 61/032,294, filed on Feb. 28, 2008.

(51) Int. Cl. G06F 17/30

(52) U.S. Cl. 705/10

(57) ABSTRACT

Disclosed is a system and method that allows a computer system the ability to predict what query terms in a search will be popular. The system creates a unified model that determines the future popularity of a query term over a period of time in the future. The unified model averages the results of three different prediction models to obtain a prediction of the future popularity of a query term. The prediction from the unified model is compared against a threshold value of popularity over a time period. When the predicted popularity of the query exceeds the threshold the term is stored. In some embodiments the period that the term exceeds the threshold may also be stored.

### CROSS-REFERENCE TO RELATED APPLICATION

This Application claims priority to U.S. Provisional Patent Application No. 61/032,294 filed Feb. 28, 2008, the contents of which are incorporated by reference herein in their entirety.

### TECHNICAL FIELD

This description relates generally to visitation of websites and services and more specifically to the prediction of the future popularity of websites and services.

### BACKGROUND

Search engines and other users of the internet that provide advertising space on their space rely on the historical analysis of queries to determine how to charge for advertising. In particular, the more popular a query term has been in the past the more a search engine can charge an advertiser for that term. Thus, advertisers are paying for advertising based upon past performance of specific query term. However, the past performance of a query term is no guarantee that that term will continue to be popular.

### SUMMARY

The present embodiments are directed to a system and method that allow search engines and other users who sell advertising space the ability to predict what query terms will be popular. The system creates a unified model that determines the future popularity of a query term over a period of time in the future. The unified model averages the results of three different prediction models to obtain a prediction of the future popularity of a query term. The prediction from the unified model is compared against a threshold value of popularity over a time period. When the predicted popularity of the query exceeds the threshold the term is stored. In some embodiments the period that the term exceeds the threshold may also be stored.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a graph illustrating a comparison between the traditional model and the unified model of the present embodiments.

FIG. 2 is a block diagram illustrating components of the prediction system according to one embodiment.

FIG. 3 is a graph illustrating the historic data of two correlated queries, Cabela's and Overstock.

FIG. 4 is a graph illustrating the historic data of two correlated queries, CNN and MSNBC.

FIG. 5 is a graph illustrating a comparison between the correlation model and the traditional model according to an illustrative embodiment.

FIG. 6 is a graph illustrating a comparison between the correlation model and the traditional models on a query CNN according to one embodiment.

FIG. 7 is a comparison between the periodicity model of one embodiment and the traditional model over all queries whose series data are periodic.

FIG. 8 is a graph of a comparison between the periodicity model and the traditional models for the query “dictionary” according to one embodiment.

FIG. 9 is a graph illustrating a comparison between the unified model, the correlation model and the traditional model for query CNN according to one embodiment.

FIG. 10 is a graph illustrating a comparison between the unified model, the correlation model and the traditional model for query dictionary according to one embodiment.

FIG. 11 is a graph illustrating a comparison between the traditional model, the aggregated model and the unified model over all queries according to one embodiment.

FIG. 12 is a series of graphs illustrating the hotness detection results of query CNN against the actual data and the predictions produced by the traditional model, the correlation model, and the unified model according to one embodiment.

FIG. 13 is a series of graphs illustrating hotness detection results of query dictionary against the actual data and the predictions produced by the traditional model, the correlation model, and the unified model according to one embodiment.

FIG. 14 is a block diagram illustrating a computing device which can implement prediction system of the present embodiments.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The Internet nowadays impacts a majority of the population through a variety of web services (e.g. websites, streaming media, etc). Therefore, the detection of hotspots on the internet, such as web services, may become more and more important for both users and providers of web services. For example, content providers would benefit by emphasizing the hottest portion of what they deliver so as to attract more users. End users would benefit by allowing them to filter large amounts of information that are of less interest to them. Search engine designers would benefit by improve the search results by re-ranking based on the hotspots, and may also help distribute the traffic through load balance techniques. For advertisers, bidding for the hottest keywords would help increase the click rates, and hence the overall effectiveness of their ads.

Currently, the query logs that are collected by a website, such as search engines, have been utilized in various ways. For example, queries submitted by end users directly reflect the users' intention, and have been effective in revealing what is currently or has been hot on the Web. By computing a curve of the frequencies within evenly split time spans, products have been developed that can display the rise or fall of the popularities of each query. Users of these products can easily observe which topics have been hot in the past by locating the peaks of the curves.

However, the information provided by the currently existing products is limited to the historical hotness of each query. These products cannot predict what is going to be hot on the Web in the future.

There currently exists a number of challenges for predicting the upcoming hotness for queries. First, the query data often shows evident periodic characteristics, but traditional prediction models do not take this fact into consideration, and hence unable to work on such kind of data. This limitation becomes especially evident when the current approaches are employed for long-term prediction rather than short-term prediction. Furthermore, for queries whose frequencies might be significantly influenced by external accidental factors (e.g. a major news event), the performance of traditional approaches based on historical data cannot meet basic requirements for hotness prediction.

The following discussion is directed to a unified model for predicting the upcoming hotness on the web. Briefly, the periodicity of the query data is explicitly modeled with Cosine model, which provides advantages over traditional prediction models on periodic data, particularly for long-term prediction. Further, the temporal correlation between related queries is modeled to handle negative influences coming from external accidental factors (e.g. major news event) within the inter-query information. Finally, the prediction performance is further boosted by unifying the traditional prediction models with the models that are discussed below.

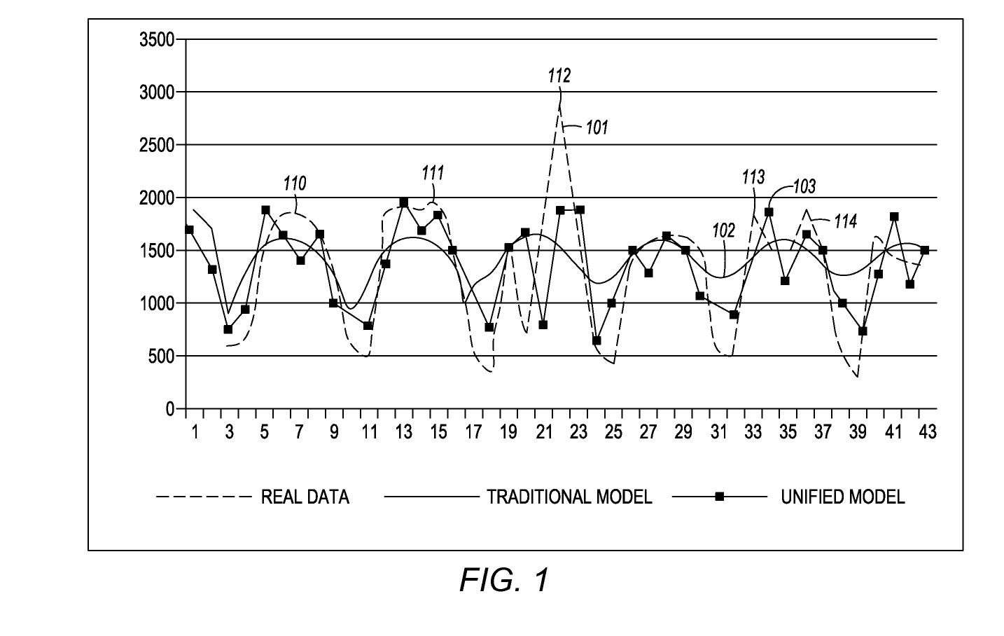

Referring now to FIG. 1, FIG. 1 is a graph illustrating the comparison of the unified model discussed herein with a traditional model and the actual data from a query log. In this example, the actual data 101 is a query of “CNN”. The series of the query log is over a period of 283 days. The first 240 days of the query log are used for training and the remaining 43 days are plotted for the comparison. The detailed predictions produced by the traditional prediction model 102 and the unified model 103 are illustrated in FIG. 1. It can be seen from FIG. 1 that the unified model 103 more closely follows the actual data 101 than does the traditional prediction model 102.

Based on the frequency prediction, the hot intervals 110, 111, 112, 113, 114 can be detected from the prediction curves 102 and 103 and compared against the actual data curve 101. The result are shown in Table 1 below, where the unified model detected all six hot intervals, while the traditional prediction model fails to detect the fifth hot interval 114.

TABLE 1

| | Hot intervals detected (days) |
|---|---|
| Real Data | 4-6, 11-13, 19-21, 25-27, 32-34, |
| | 39-39 |
| Traditional Model | 3-5, 11-14, 20-21, 32-34, 40-40 |
| Unified Model | 3-5, 11-14, 19-21, 26-26, 32-34, |
| | 40-40 |

In the present discussion conventional query representation for time series data, namely discontinuous frequency function are used. A query is represented as a sequence of integers, each of which stands for the issued number of the query at that time unit. The frequency function of a query Q over M time units is an M-dimension vector,

Q={q₁, q₂, . . . , q_{M}}, Equation 1

where q₁ represents the aggregate clicks of Q on the ith time unit, and M is the total length of the series. A time unit can be an hour, a day, a week, a month or any other time unit desired.

In Equation 2 the prediction problem as foretelling a number of next steps based on the historical values of a time series is defined. Given the first N elements of the time series Q, the problem of (M-N)-step prediction is defined as

{\hat{q}_{N+1}, \hat{q}_{N+2}, . . . , \hat{q}_{M}}=ƒ(q₁, q₂, . . . , q_{N}), Equation 2

Where f is the mapping function describing the relationship between the first N elements and the last M-N elements of Q. Then, the objective of model training is to minimize the error between the frequency prediction {\hat{q}_{N+1}, \hat{q}_{N+2}, . . . , \hat{q}_{M}} and the ground truth {q_{N+1}, q₂₊₂, . . . , q_{M}}.

Finally, the problem of hotness detection as finding the hot intervals, that is, areas with unusually high values within a given series is defined. A hot interval is may also be called a burst.

Given the l prediction values {\hat{q}₁, \hat{q}₂, . . . , \hat{q}ₗ}, the hotness detection problem is defined to find d discrete intervals [b1, e1], [b2, e2], . . . , [bd, ed] so that

1) 1≦b₁≦e₁<b₂≦e₂< . . . <b_{d}≦e_{d}≦t

2) The values within the interval [bi, ei] are statistically sufficient to constitute a burst in the concerned series, that is, all these values are unusually much larger than the average value of the entire series. These bursts are considered to be the candidate hotspots of the entire series.

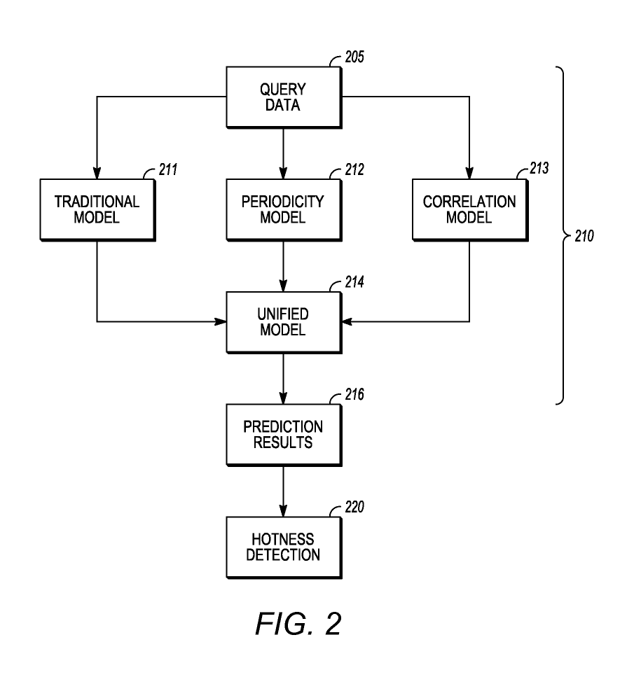

Referring now to FIG. 2, the main components of the hotness prediction framework to harness the information from related queries for predicting the upcoming hotness is discussed. FIG. 2 is a block flow diagram illustrating the hotness prediction framework according to one illustrative embodiment. The hotness prediction framework 200 includes two parts: the frequency prediction component 210, which predicts the future frequency values of a given query, and the hotness detection component 220, which detects the hot intervals/bursts within the predictions for a given query.

The frequency prediction component 210 includes three sub-models, the traditional prediction model 211, the periodicity model 212 and correlation model 213 which are then used to generate the unified model 214. These models receive data from the query data 205 which are data logs of at least one query from a service such as a search engine. The traditional prediction model 211 is in one embodiment uses conventional time series analysis techniques. The periodicity model 212 meliorates the prediction performance by uncovering latent periodicities of the query frequency series. The correlation model 213 operates on a theory that there often exists mutual causal relationship among different queries. Finally, a unified model 214 is provided to leverage the different models thus obtaining better prediction accuracy. The processes used by the unified model 214 is described in Table 2 below.

TABLE 2

```
INPUT Time series Q={q₁,q₂,...,q_{N}}
OUTPUT Prediction \hat{Q}
STEP 1 If detect_correlation(Q)=TRUE
    \hat{Q}_{correlation} = predict_correlation(Q)
STEP 2 \hat{Q}_{traditional} =predict_tradtional(Q)
STEP 3 If detect_periodicity(Q)=TRUE
    \hat{Q}_{periodicity} = predict_periodicity(Q)
STEP 4 β=regression(\hat{Q}_{correlation},\hat{Q}_{traditional},\hat{Q}_{periodicity})
STEP 5 \hat{Q}=predict(Q,β)
```

The present embodiments also include a method for accelerating the computation for large size databases. In contrast to learning the weights assigned to the prediction result of each component model, the weights are calculated by giving a unit weight to a specific model if the series data is detected to fit that model. For example, if the series of a query has other correlated queries, the weight for \hat{Q}_{correlation} is set as 1, otherwise 0. Finally, the prediction is obtained by averaging the prediction results from different models with these weights. This simplified model is referred to as the aggregated model. The aggregated model is better than the unified model in efficiency yet worse in effectiveness.

Referring to the hotness detection component 220 of the framework 200, the hotness detection component 220 in one embodiment employs a method based on a moving average (MA) and applies this method to the frequency prediction results 216 obtained from the frequency prediction component 210 so as to determine upcoming hot intervals of a given series.

The following sections will discuss in more detail the features and process employed by the various models used in frequency prediction part 210 of the framework according to various embodiments.

Traditional Prediction Model

In one embodiment, the traditional prediction models 211 uses an autoregressive model (AR) for time series analysis. An AR model of order p denoted as AR(p) is formulated as

$${q}_{t} = c + {\sum }_{i = 1}^{p} {ϕ}_{i} {q}_{t - i} + {ɛ}_{t} , \qquad Equation 3$$

where c is a constant, φ₁, . . . , φₚ are the model parameters, and εₜ is the error term. In some embodiments, the AR model can be treated as an infinite impulse response filter.

The parameters of the AR model are estimated in one embodiment using Yule-Walker equations, and in another embodiment using least square regression. For the purposes of this discussion it is presumed that the AR model is using least square regression. A standard “windowing” transformation can be used to transfer a time series into a set of instances for regression analysis. Given a time series

Q=(q₁, q₂, . . . , q_{N}), Equation 4

an instance for regression analysis is defined as

yₜ=(qₜ, qₜ₊₁, . . . , qₜ₊ₚ)^{T} Equation 5

Thus the AR parameters can be calculated by solving the following equation

ΦY=0, Equation 6

where:

Φ=(φ₁, φ₂, . . . , φₚ, −1), Equation 7

Y=(y₁, y₂, . . . , y_{N-p}), Equation 8

As described above, the time series problem can be transformed into a regression problem, and thus any regression technique can be applied for solving this problem. It should be noted that the predictor values in regression analysis correspond to the preceding values in time series and the target value corresponds to the current value.

The Periodicity Model

In one embodiment the periodicity model 212 implements the Cosine Signal Hidden Periodicity (CSHP) model discussed below which can detect the periodicity of a given time series effectively and consequently can make predictions for long-term trends.

There often exists periodicity property for real time series. In the field of Digital Signal Processing (DSP), the Cosine model is often adopted to approach periodic data series as

$${q}_{t} = {\sum }_{j = 1}^{k} {A}_{j} cos ( {ω}_{j} t + {ϕ}_{j} ) + {ξ}_{t} , \qquad Equation 9$$

where positive real number Aⱼ is the Amplitude of Angular Frequency ωⱼ, φⱼ is the Phase of ωⱼ. Equation 9 is referred to as the Cosine Signal Hidden Periodicity (CSHP) model, from which it is possible to obtain the periodicities of qₜ as

Tⱼ=2π/ωⱼ·j=1, 2, . . . , k, Equation 10

Then the frequency spectral of the model is given by

$${S}_{N} ( λ ) = {\sum }_{t = 1}^{N} {q}_{t} {e}^{- i λ t} λ ∈ [ - π , π ] , \qquad Equation 11$$

and has the following lemma:

Lemma 1. if ∃k and λ*ⱼ such that S_{N}(λ*ⱼ)≧S_{N}(λ), where λε[λ*ⱼ−1/2_{\sqrt{N}}, λ*ⱼ+1/2_{\sqrt{N}}] and j=1, 2, . . . , k, then the CSHP Model (1) has k periodicities, and the parameters are estimated by

$${ω}_{j} = {λ}_{j}^{*} , \\ {T}_{j} = \frac{2 π}{{ω}_{j}} = \frac{2 π}{{λ}_{j}^{*}} , \\ {α}_{j} = {\sum }_{t = 1}^{N} {q}_{t} {e}^{- i {λ}_{j}^{*} t} , \\ {A}_{j} = 2 \vert {α}_{j} \vert \\ and \\ {ϕ}_{j} = arg ( {α}_{j} ) . \qquad Equation 12$$

Using Lemma 1 a Periodicity Detection Algorithm (PDA) as illustrated in Table 3 below, is generated to determine the periodicity of the time series related with a query.

TABLE 3
INPUT Time series Q = {q₁, q₂, . . . , q_{N}}
OUTPUT The periodicity T of Q if it is a seasonal query
STEP 1. Compute the mean of Q: $\overline{Q} = \frac{1}{N} {\sum }_{t = 1}^{N} {q}_{t}$
STEP 2. Centralize Q to a zero mean series χ:

xₜ = qₜ − Q̅, t = 1, 2, . . . , N

STEP 3. Calculate S_{N}(λ) by equation (2) and judge whether S_{N}(λ) has
peaks based on Lemma 1.
STEP 4. If S_{N}(λ) has k peaks, output the periodicity Tⱼ. Otherwise,
Q is not periodic.

Based on the detected periodicities and estimated parameters illustrated in table 3, the CSHP model, according to one embodiment is established and applied for time series prediction. The routines for prediction with CSHP are illustrated in Table 4.

TABLE 4

INPUT A periodic time series Q = {q₁, q₂, . . . , q_{N}}
OUTPUT Prediction \hat{Q}
STEP 1. Estimate the parameters of the CSHP Model on Q:

(EX4)

${q}_{t} = \overline{Q} + {\sum }_{j = 1}^{k} {A}_{j} cos ( {ω}_{j} t + {ϕ}_{j} ) + {ξ}_{t}$

STEP 2. Get the prediction \hat{Q} = (\hat{q}_{N+1}, \hat{q}_{N+2}, . . . , \hat{q}_{M}).

Correlation Model

The correlation model 213 uses information form related queries to predict upcoming trends. A measure of temporal similarity is used by the correlation detection model 213. For the time series related to a given query Q, first a normalization step is conducted for each time series. Let SUMi be the total number of queries (not necessarily distinct) at the ith time unit, Q is normalized as

\tilde{Q}={\tilde{q}₁, \tilde{q}₂, . . . , \tilde{q}_{M}}, Equation 13

where \hat{q}ᵢ=qᵢ/SUM

The temporal similarity is defined by considering qᵢ of each query as a random variable. The correlation coefficient between two time series Q and R is defined as

$$sim ( \tilde{Q} , \tilde{R} ) = \frac{1}{M} {\sum }_{i} ( \frac{{\tilde{q}}_{i} - μ ( \tilde{Q} )}{σ ( \tilde{Q} )} ) ( \frac{{\tilde{r}}_{i} - μ ( \tilde{R} )}{σ ( \tilde{R} )} ) \qquad Equation 14$$

where μ(\tilde{Q}) is the mean frequency of the normalized time series \tilde{Q} and σ(\tilde{Q}) is the standard deviation.

The similarity lies within [−1, 1], where 1 indicates an exact positive linear relationship, −1 indicates the opposite, and 0 indicates full independence.

Based on the detected correlated queries, the correlation model 213 utilizes the information from all the correlated queries for query prediction. Let W¹, W², . . . , W^{c} be the c correlated queries of Q, and

Wⁱ=(w₁ⁱ, w₂ⁱ, . . . , w_{N}ⁱ). Equation 15

First, the same “windowing” transformation is applied for data preprocessing. Then, an instance over the concerned query and the correlated queries is defined as

yₜ=(qₜ, . . . , pₜ₊ₚ₋₁, wₜ¹, . . . , wₜ₊ₚ₋₁¹, . . . , wₜ^{c}, . . . , wₜ₊ₚ₋₁^{c}, qₜ₊ₚ)^{T} Equation 16

Similarly, the following linear equation is used for estimating the model parameters,

ΦY=0 Equation 17

where

Φ=(φ₁, . . . , φₚ, φ₁¹, . . . , φₚ¹, . . . , φ₁^{c}, . . . , φₚ^{c}, −1), Equation 18

Y=(y₁, y₂, . . . , y_{N-p}), Equation 19

It should be noted that in some embodiments the regression can be solved using linear least square technique. As more information is used for prediction the model becomes more powerful. The details of prediction with the correlation model 213 according to one embodiment are listed in Table 5 below.

TABLE 5

INPUT Time series Q={q₁,q₂,...,q_{N}}
OUTPUT Prediction \hat{Q}
STEP 1 Normalize Q and find its related series
W^{l},...,W^{c}.
STEP 2 Build a regression model based on Q and
W^{l},...,W^{c}.
STEP 3 Get the prediction \hat{Q}=(\hat{q}_{N+1},\hat{q}_{N+2},...,\hat{q}_{M}).

The three models 211, 212, 213 described above for frequency prediction, are now correlated into a unified model 214 that can be used for hotness detection, according to one embodiment. In this embodiment, a moving average (MA) is computed. Hot intervals according to one embodiment are discovered by identifying MA of at least Y standard deviation above the mean value of all MA's. A more detailed explanation is provided in Table 6 below.

TABLE 6

INPUT Time series Q={q₁,q₂,...,q_{N}}
OUTPUT A set of bursts B=(b₁,b₂,...,bₛ), where
bᵢ=[start_date, end_date].
STEP 1 Calculate the Moving Average MA_{Q} of
sliding window length wfor Q.
STEP 2 Set cutoff =mean(MA_{Q})+γ·std(MA_{Q})
STEP 3 Calculate the hot points in ascending
order: {tᵢ|MA_{Q}(i)>cutoff}
STEP 4 Compact the hot points into a series of
hot intervals [b₁, e₁],[b₂, e₂],...,[b_{d}, e_{d}].

The following discussion is an example of an implementation of the hotness prediction methods according to one illustrative embodiment. In this example, actual query data from the MSN search engine was used. From a collection of 15,511,531 queries along with their daily aggregate clicks from October 2006 through August 2007, or 283 days in total, specific queries were obtained. In particular the present example used queries for the terms “CNN” and “dictionary” for the analysis. The algorithmic performance of the present embodiments in improving query frequency prediction and hotness detection are compared in detail with traditional models.

The following presents experimental results of the present embodiments on query frequency prediction. In particular the correlation model for queries influenced by accidental factors, the periodicity model for periodic series, and the unified model over all queries are evaluated. These models are then compared with traditional models to illustrate at least one of the advantages of the present embodiments.

The following is a description of the configuration used for the validating the present embodiments. First the model parameters for different prediction models and the parameters related with the present configurations are estimated. As discussed above when testing the approach of the present embodiments the data is divided into training data and testing data. The training data should be sufficiently large to ensure the accuracy of model parameters, and the length of the test series should not be too long as to be unpredictable. In the present example, the data for the first 240 days is used as the training data, and the remaining 43 days are used for testing.

The number of autoregressive terms p, namely the number of historical data used for prediction are set. Generally, the more autoregressive terms lead to better prediction, but result in heavier computation cost and possible overfitting. For purposes of the present comparisons p is set as 10 empirically.

The threshold to determine whether two time series are correlated in terms of temporal semantics must also be selected. In the present example, the value of 0.9 is selected for the correlation threshold.

Parameters for traditional time series models other than AR are also selected. These parameters include the degree of differencing and the moving average order. The present examples use the Akaike Information Criterion (AIC) to determine the appropriate values for these parameters.

In addition, we adopt RMSE (Root Mean Square Error) [2] as the measurement to evaluate the accuracy of the frequency prediction results. The definition of RMSE is given as

$$R M S E ( x , y ) = \sqrt{\frac{{\sum }_{i = 1}^{n} {( {x}_{i} - {y}_{i} )}^{2}}{n}} , \qquad Equation 20$$

where x is the original time series, y is the corresponding predicted time series.

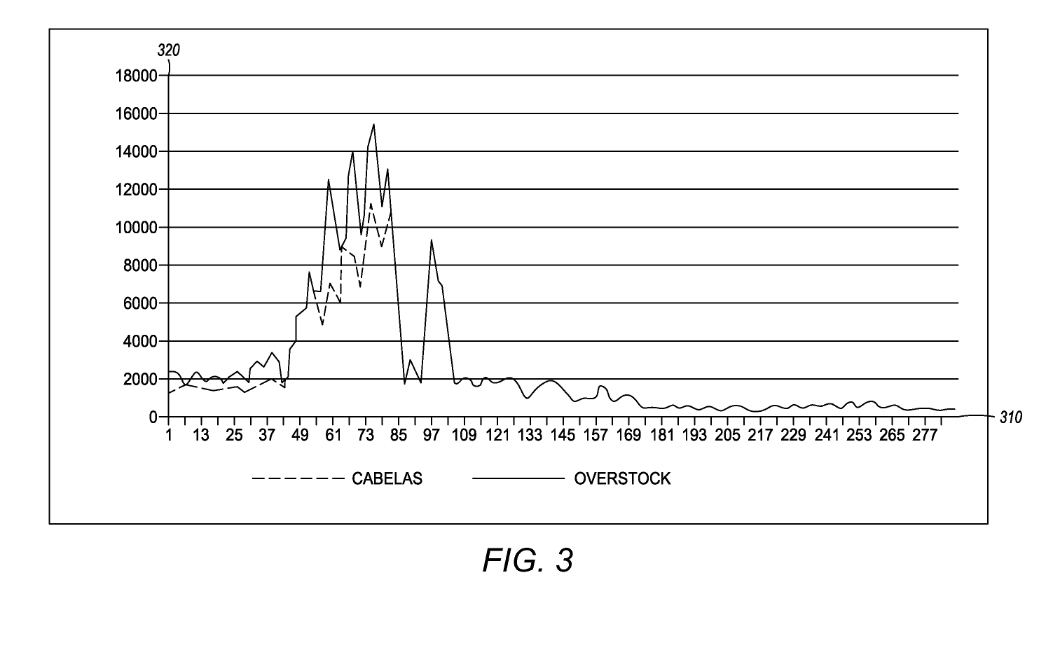

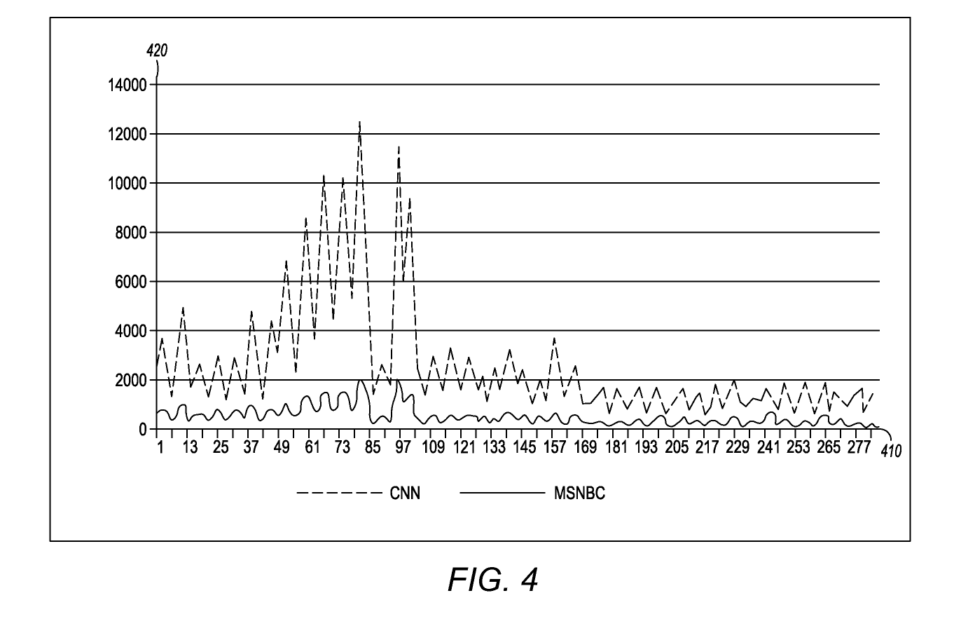

The present example implements a semantic similarity measure as as discussed in Chin et al to search for the related queries of a given query. By following the parameter settings of Chin et al, it was observed that about 17.6% of the queries have temporally correlated queries. FIG. 3 and FIG. 4 illustrate two examples of these correlated queries.

As illustrated in FIG. 3, the query term “cabelas” stands for the largest outdoor outfitter in the world, and the query term “overstock” is an Internet leading shop for brand names. Another example is shown in FIG. 4, where the query term “CNN” and query term “MSNBC,” which are both famous news websites. In these Figures the x-axis 310, 410 represents the day of the query and the y-axis 320, 420 represents the frequency of the query.

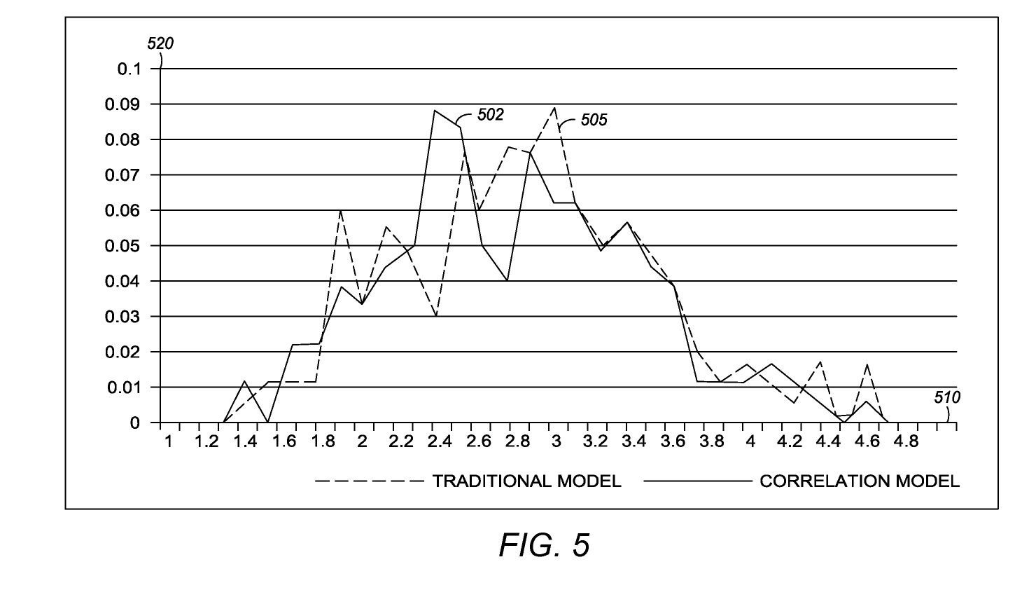

FIG. 5 is a graph comparing the predication capabilities of a traditional prediction model versus the correlated model of the present embodiments using the AR model. Line 501 represents the traditional model and the correlated model is represented by line 502. The lines are plotted where the x-axis 510 represents the log value of the error measure (in one embodiment RMSE), and the y-axis 520 represents the number of queries with error measure. The graph of FIG. 5 shoes that the correlation model outperforms the traditional model except a few exceptions. Averaging the error measure values over all queries involved shows an error measure of 789.23 for the traditional model and an error measure of 633.79 for the correlation model. Thus, the correlation model of the present embodiments shows considerable advantage over the traditional model.

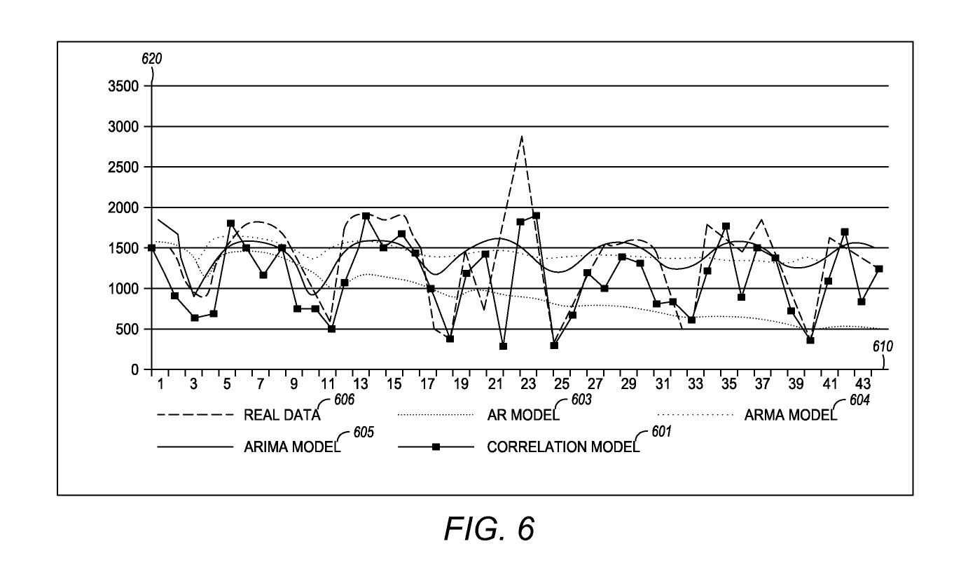

FIG. 6 is a graph illustrating frequency prediction of the correlation model 601 versus a number of traditional prediction models 603, 604 and 605. For the prediction in FIG. 6 all of the models were run against query data for the query “CNN” and the prediction results for the last 43 days' data are illustrated in FIG. 6. In FIG. 6 the x-axis 610 represents the days and the y-axis 620 represents the number of queries. FIG. 6 illustrates that the AR model 603, which is the simplest prediction model, performs the worst and degrades sharply as the time increases. The ARMA 604 model performs better in keeping to the average value, but fails to model the periodicity in the series data. Unsurprisingly, the best result is given by ARIMA model 605 which is the most complex among the three traditional models. However, the results of ARIMA are not satisfactory for the peak values of its prediction as these values are considerably smaller than the actual data 605. The correlation model 601 outperforms all of the traditional models and best approaches the actual data 602.

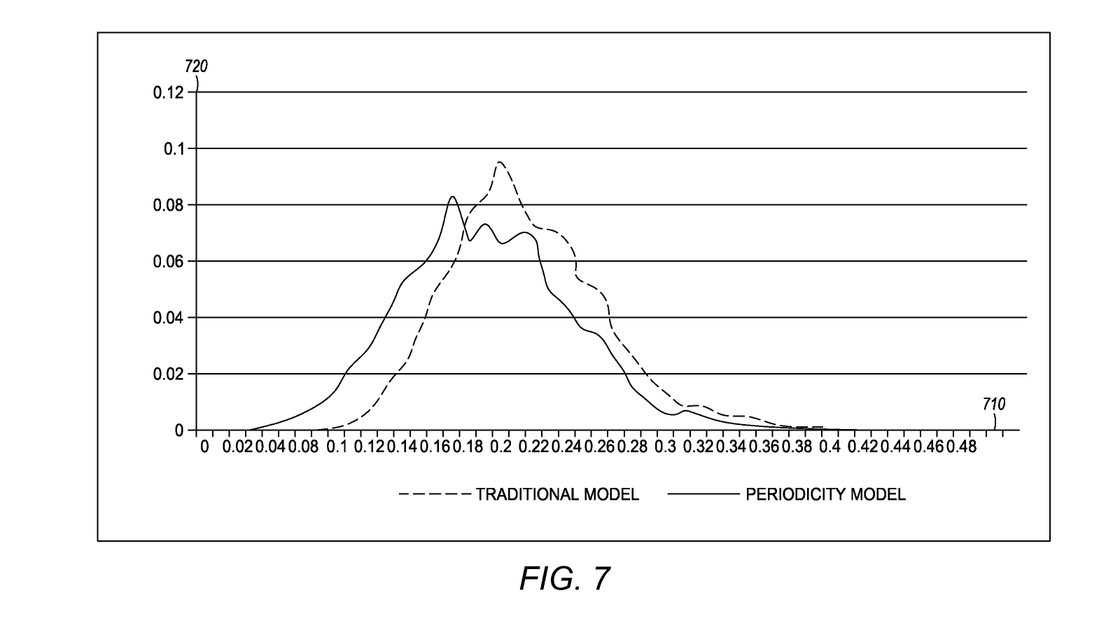

FIG. 7 is a graph illustrating the prediction capability of the periodicity model of the present embodiments versus one of the traditional models. The x-axis 710 denotes the log value of the error measure (e.g. RMSE), while the y-axis 720 represents the percentage of queries among the total with the corresponding log of the error measure. From FIG. 7, the performance of CSHP model almost overwhelms traditional models because it models the hidden periodic data patterns, where the periodic model yields much less high-error measure prediction results and more low-error measure prediction results. A comparison of the prediction results of AR and CSHP in a case-by-case manner, the CSHP model outperforms the AR model in 84.2% of the cases, with a mean error measure of 149.521 over a mean error measure for the AR model of 250.785.

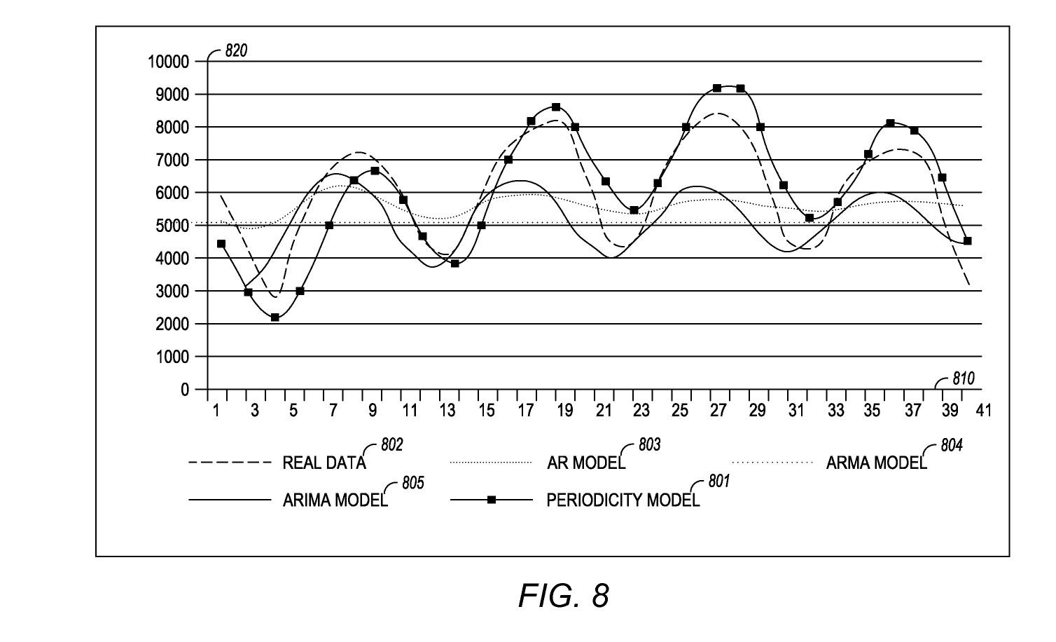

FIG. 8 is a graph of a query for “dictionary” comparing the traditional models to the CSHP model of the present embodiments. As illustrated in FIG. 8, the values of the series show apparent periodic characteristics. Again, three traditional prediction models: AR 803, ARMA 804 and ARIMA 805 are presented. As shown in FIG. 8 query, both AR 803 and ARMA 804 models perform poorly for this query and tend to predict a constant value for future trends. The ARIMA model 805 is better, but still does not approach the actual data 802. Again the CSHP model 801 performs significantly better than the traditional models in periodicity prediction.

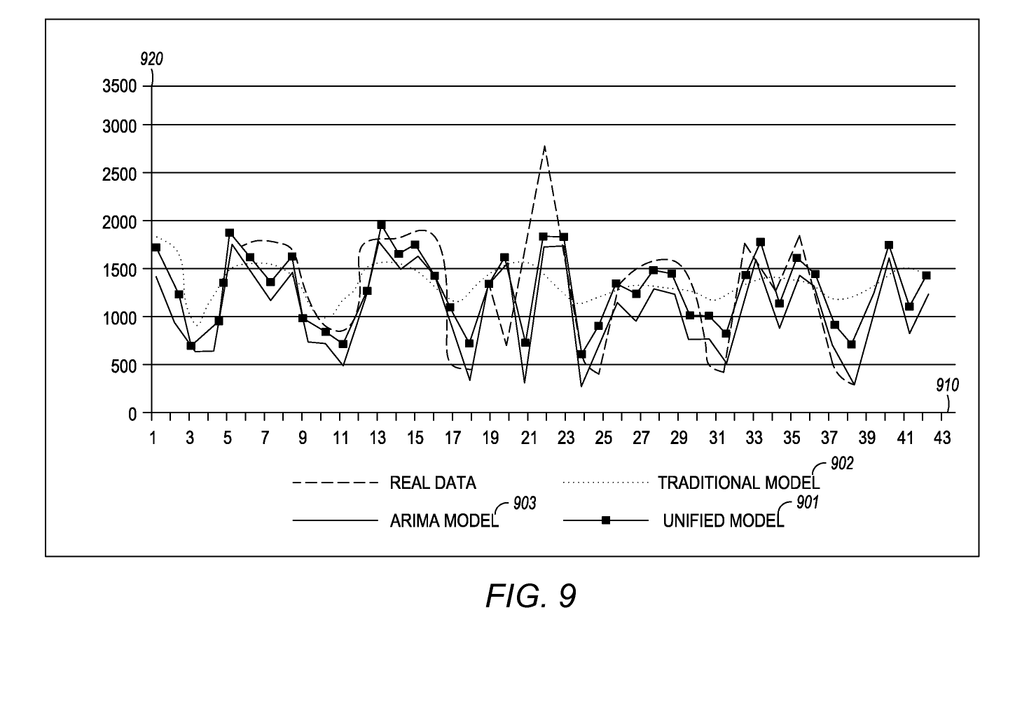

FIGS. 9-11 are graphs illustrating the evaluation results of the unified model according to the present embodiments. As discussed above the unified model combines the traditional model, correlation model and periodicity model. The evaluation of the unified model is based on a comparison between different models in terms of prediction error.

TABLE 7

| Model | Traditional | Correlation | Unified |
|---|---|---|---|
| Mean RMSE | 500.477 | 461.335 | 390.774 |

The results produced by three models are plotted in FIG. 9: the traditional model 902 (the ARIMA model was chosen as it performs best among all the discussed traditional prediction models), the correlation model 903 and the unified model 901. The x-axis 910 represents a number of days and the y-axis 920 represents the number of queries. In particular FIG. 9 illustrates the results of the prediction on a time series for the query of CNN. The prediction results are based on the training data (i.e. data belonging to the first 243 days). The training data is used to learn the coefficients for the unified model. In the present example, the weight assigned to the traditional model is 0.36 and that to the correlation model is 0.73. Table 7 above displays the numerical version of the results shown in FIG. 9. Thus it becomes clear that the unified model of the present embodiments achieves a better result than other models.

TABLE 8

| Model | Traditional | CSHP | Unified |
|---|---|---|---|
| Mean RMSE | 1355.991 | 990.502 | 644.131 |

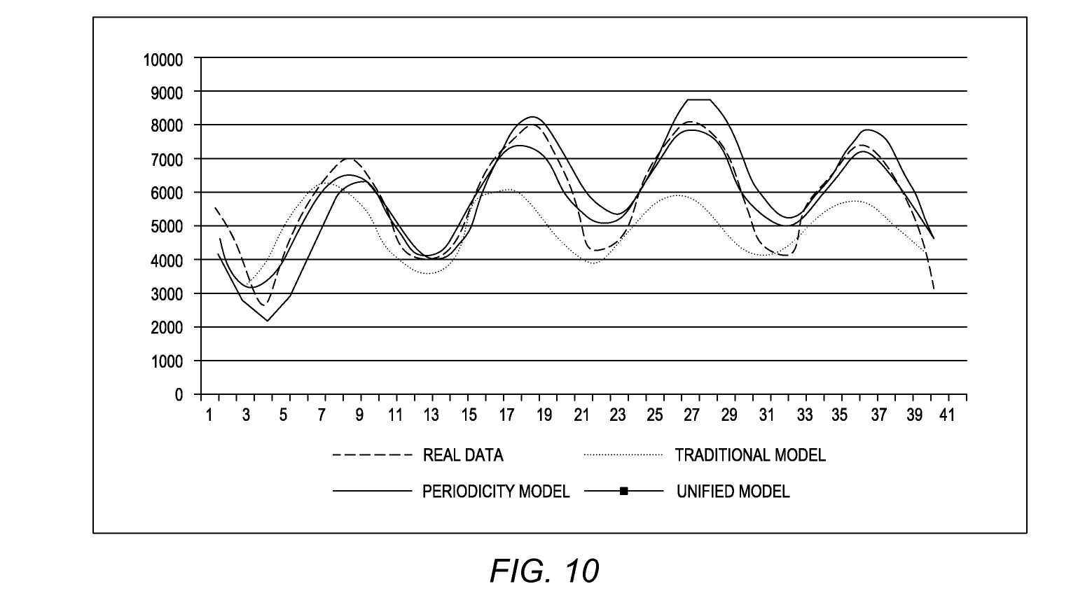

FIG. 10 is a graph of a second example of the unified model for the time series for the query “dictionary”. This time series exhibits apparent periodicities. Again a comparison of the performances of traditional model (ARIMA), periodicity model and unified model is illustrated. Again we can find that the unified model outperforms its rivals significantly by delicately incorporating the advantages from both traditional model and periodicity model. The numerical results in terms of mean RMSE along all time slots are shown in Table 8, where we can again see that the unified model is much better than the other models. As for the coefficients of regression, we note that the weight of periodicity model (0.55) is slightly higher than the traditional one (0.51), which may be due to the fact that the ARIMA model itself can model the periodicities within the series data, thus the further improvement CSHP model over ARIMA is limited in some cases.

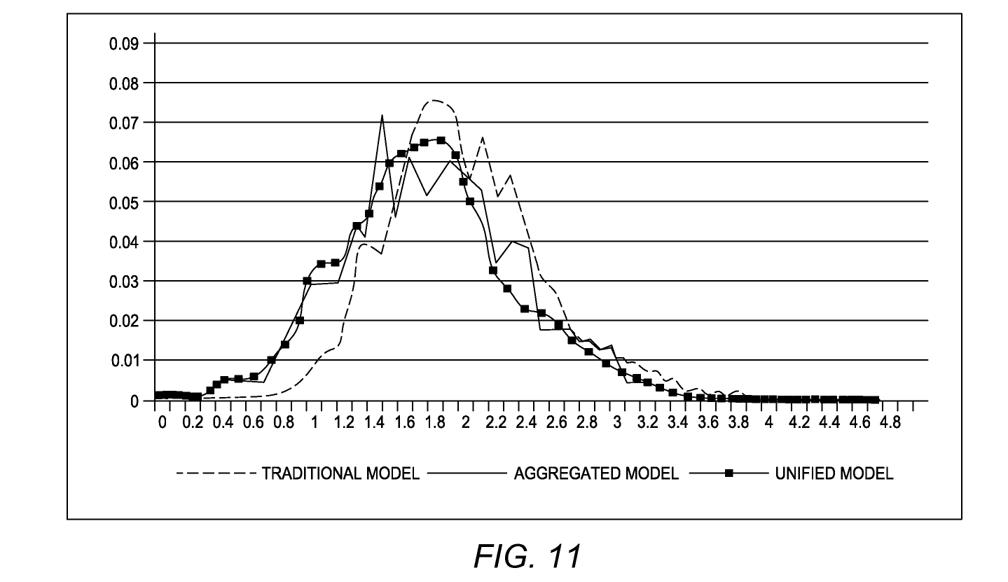

Finally, the traditional model, unified model and aggregated model over all the time series are compared. This comparison is illustrated in the graph of FIG. 11. As discussed above the traditional model does not outperform either the aggregated model or unified model. Further, the unified model achieves considerably better performance than the aggregated one. Based on the above comparisons it becomes clear that the unified model of the present embodiments is capable of producing stable and accurate prediction on time series related with query data, and provides a solid foundation for the hotness detection discussed below.

The following presents a series of experimental results illustrating the predictions given by each model discussed above compared to the real hotspots for the experimental data. These results confirm the conclusion drawn above with respect to the unified model of the present embodiments as against the traditional models.

As illustrated in Table 6, two parameters are determined in hotness detection process. The first parameter is the size of sliding window when applying moving average on the original time series data, and the second parameter is the parameter γ which stands for the number of standard deviations required. In the present experiment, the window size was set to be 2 or 3 days, and good values for γ are within [0.5 1.0].

To measure the algorithmic effectiveness in detecting relevant hot intervals of different models, Burst Similarity Measure (BurstSim) is used where the similarity between two series of bursts

B^{(x)}=(b₁^{(x)}, b₂^{(x)}, . . . , bₛ^{(x)}), B^{(y)}=(b₁^{(y)}, b₂^{(y)}, . . . , bₜ^{(y)}) Equation 21

is denoted as

$$\begin{matrix}BurstSim = {\sum }_{i = 1}^{s} {\sum }_{j = 1}^{t} cross ( {b}_{i}^{( x )} , {b}_{j}^{( y )} ) , & Equation 22 \\ cross ( {b}_{i}^{( x )} , {b}_{j}^{( y )} ) = \frac{1}{2} ( \begin{matrix}\frac{overlap ( {b}_{i}^{( x )} , {b}_{j}^{( y )} )}{\vert {b}_{i}^{( x )} \vert} + \\ \frac{overlap ( {b}_{i}^{( x )} , {b}_{j}^{( y )} )}{\vert {b}_{i}^{( y )} \vert}\end{matrix} ) & Equation 23\end{matrix}$$

where overlap(bᵢ^{(x)}, bⱼ^{(y)}) means the size of time intersection between two bursts. For example, overlap([1,3],[2,5])=2.

First, the hotness detection algorithm mentioned in Table 6 above is used on the real time series of a query to get the corresponding bursts, denoted as BO. Then the prediction results of each model are input into the detection algorithm to get a series of bursts for each query. Finally, the BurstSim between the output bursts and BO is calculated. The model with the largest similarity value is considered as the one with the best prediction capability.

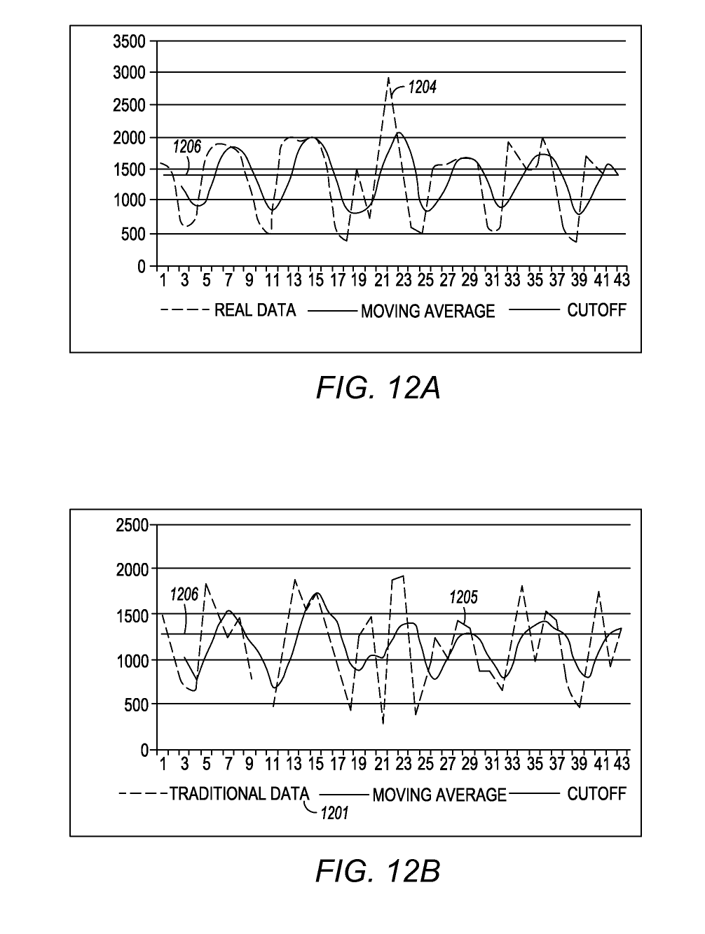

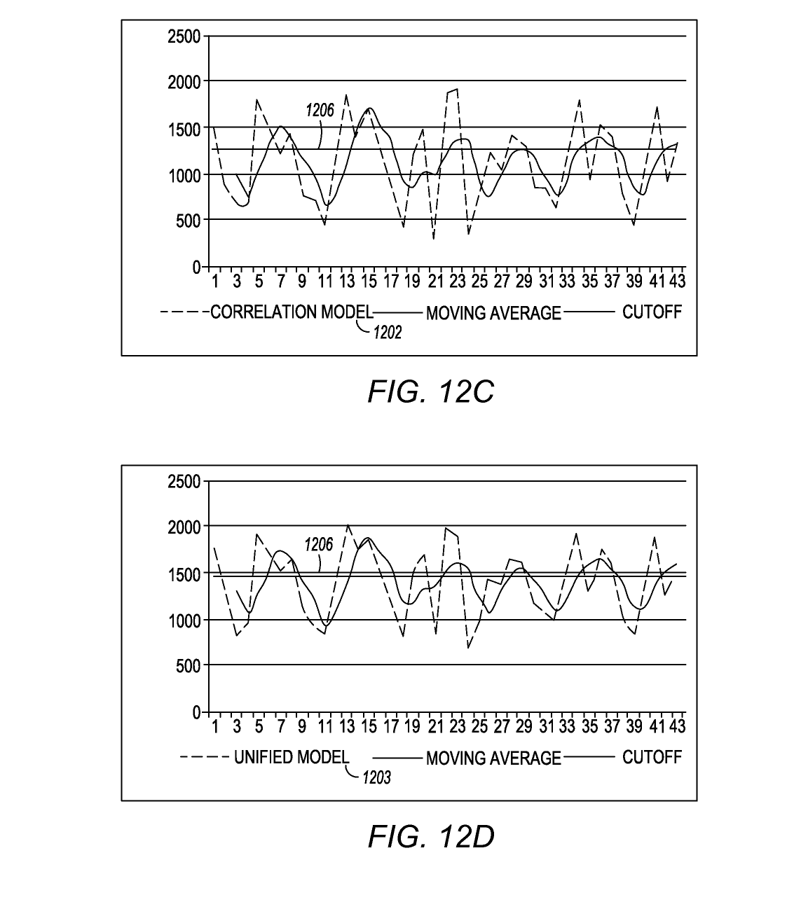

The results from the hotness detection algorithm described in Table 6 on real data of query CNN and the prediction produced by traditional model 1201, correlation model 1202 and unified model 1203 respectively are illustrated in FIG. 12. In total six hot intervals have been detected on the real data 1204. Hot intervals are designated by those periods that are above cutoff line 1206 However, the traditional model failed to detect the fourth hot interval 1205. Continuing to review the graph the correlation model performs better than the traditional model, and the unified model performs the best of all three.

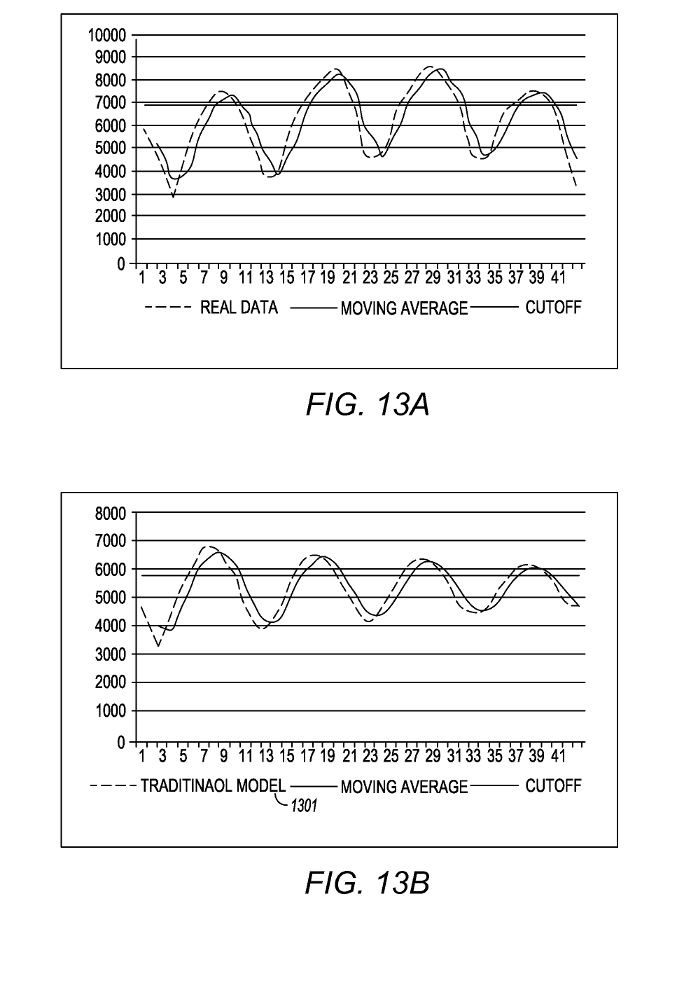

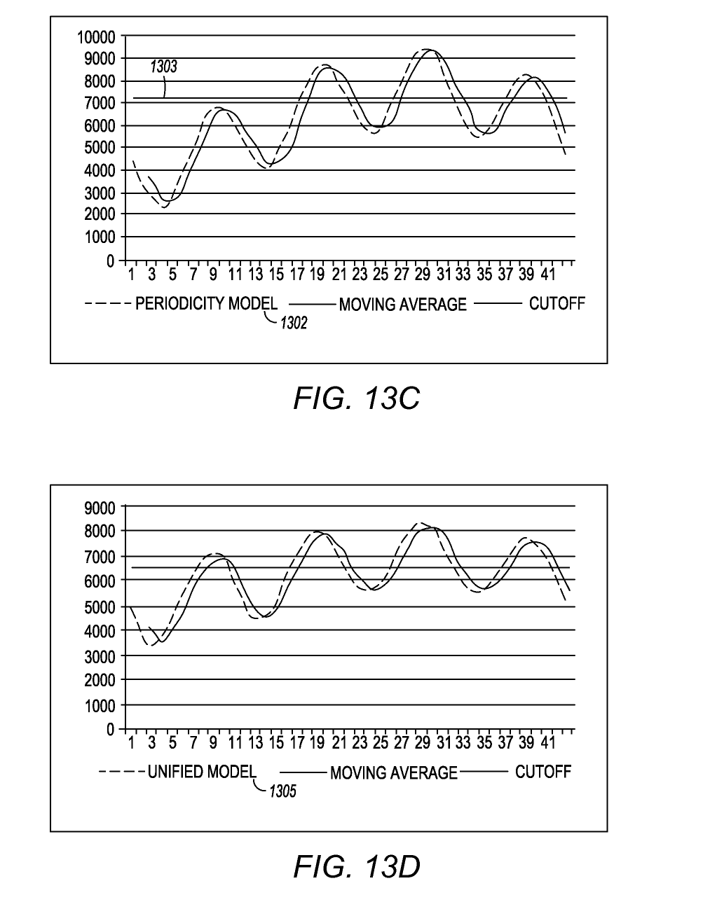

FIG. 13 is a graph that represents the experimental results on the time series of query “dictionary,” and the results are displayed in FIG. 13. For this query, the CSHP model 1302 which performs better in prediction fails to find the first hot interval 1303, which implies some defects of this Cosine model. The unified model 1305 still performs the best, which validates the necessity to combine different models for prediction and hotness detection.

TABLE 9
The BurstSim values produced by the traditional model 1301,
the correlation model and the unified model over all queries.

| Model | Traditional | Aggregated | Unified |
|---|---|---|---|
| BurstSim | 2.014 | 2.239 | 2.973 |

Finally, the traditional model, the aggregated model and the unified model are run over the time series of all queries. The results shown in Table 9 again accord with our before-mentioned observations, and the unified model performs the best among all the models.

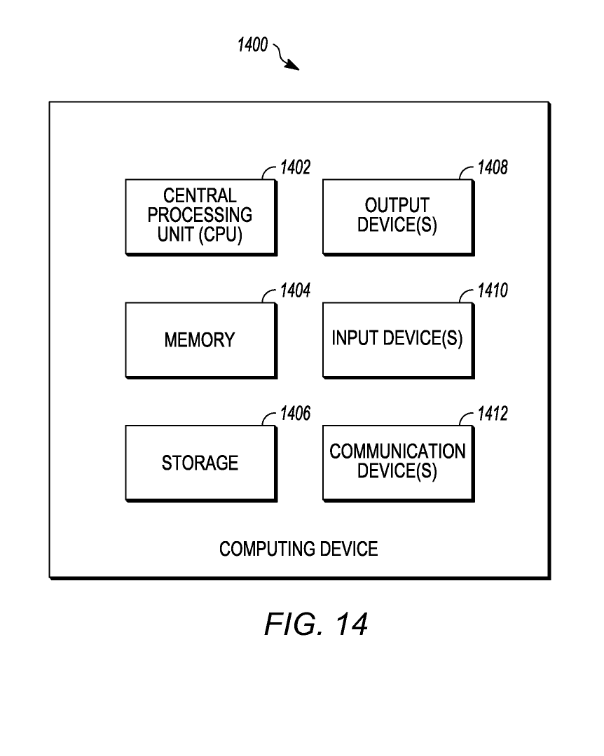

FIG. 14 illustrates a component diagram of a computing device according to one embodiment. The computing device 1400 can be utilized to implement one or more computing devices, computer processes, or software modules described herein. In one example, the computing device 1400 can be utilized to process calculations, execute instructions, receive and transmit digital signals. In another example, the computing device 1400 can be utilized to process calculations, execute instructions, receive and transmit digital signals, receive and transmit search queries, and hypertext, compile computer code, as required by the system of the present embodiments.

The computing device 1400 can be any general or special purpose computer now known or to become known capable of performing the steps and/or performing the functions described herein, either in software, hardware, firmware, or a combination thereof.

In its most basic configuration, computing device 1400 typically includes at least one central processing unit (CPU) 1402 and memory 1404. Depending on the exact configuration and type of computing device, memory 1404 may be volatile (such as RAM), non-volatile (such as ROM, flash memory, etc.) or some combination of the two. Additionally, computing device 1400 may also have additional features/functionality. For example, computing device 1400 may include multiple CPU's. The described methods may be executed in any manner by any processing unit in computing device 1400. For example, the described process may be executed by both multiple CPU's in parallel.

Computing device 1400 may also include additional storage (removable and/or non-removable) including, but not limited to, magnetic or optical disks or tape. Such additional storage is illustrated in FIG. 14 by storage 1406. Computer storage media includes volatile and nonvolatile, removable and non-removable media implemented in any method or technology for storage of information such as computer readable instructions, data structures, program modules or other data. Memory 1404 and storage 1406 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 1400. Any such computer storage media may be part of computing device 1400.

Computing device 1400 may also contain communications device(s) 1412 that allow the device to communicate with other devices. Communications device(s) 1412 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 1400 may also have input device(s) 1410 such as keyboard, mouse, pen, voice input device, touch input device, etc. Output device(s) 1408 such as a display, speakers, printer, etc. may also be included. All these devices are well known in the art and need not be discussed at length.

Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A method for determining future activity of a query term comprising:
obtaining a data log of queries from a service;
analyzing the data log to determine a relative historic frequency of query terms within the data log;
processing the determined relative frequencies through a unified model to determine a future frequency of occurrence of at least one term in the data log;
determining if the future frequency of occurrence of the at least one term exceeds a threshold value; and
storing the at least one term when the future frequency exceeds the threshold value.

2. The method of claim 1 wherein the future frequency of occurrence is determined for a predetermined time period; and
wherein storing the at least one term stores the term when the future frequency of occurrence exceeds the threshold value at some point along a predetermined time period.

3. The method of claim 1 wherein processing the determined relative frequency through the unified model comprises:
determining a prediction result of the future frequency of occurrence with a traditional model;
determining a prediction result of the future frequency of occurrence with a periodicity model;
determining a prediction result of the future frequency of occurrence with a correlation model; and
averaging the prediction results for each of the models as the unified model.

4. The method of claim 3 further comprising:
assigning a weight to the traditional model, the periodicity model and the correlation model; and
averaging the prediction results of the models according to the assigned weight.

5. The method of claim 3 wherein the average is a moving average over a predetermined time period.

6. The method of claim 3 wherein determining with the traditional model comprises implementing an autoregressive model over a time series.

7. The method of claim 3 wherein determining with the periodicity model comprises implementing a cosine hidden periodicities model over a time series.

8. The method of claim 3 wherein determining with the correlation model comprises:
identifying related queries to the at least one query term in the data log normalizing the related queries over a time series;
identifying a temporal similarity of the related queries to the at least one query term; and
applying a regression model to obtain a prediction based upon the query term and the related queries.

9. A system for determining future occurrences of at least one query term, comprising:
a frequency prediction component configured to determine the future frequency of occurrence of the at least one query term; and
a hotness detection component configured to interface with the frequency prediction component to identify query terms that exceed a threshold frequency of occurrence; and
a storage device configured to store query terms that exceed the threshold.

10. The system of claim 9 wherein the frequency prediction component further comprises:
a unified model for predicting future occurrences of the query term.

11. The system of claim 10 wherein the unified model comprises:
a traditional model configured to predict the future occurrence of the query term;
a periodicity model configured to predict the future occurrence of the query term;
a correlation model configured to predict the future occurrence of the query term; and
wherein the predicted future occurrence of the query term from each of the models is averaged.

12. The system of claim 11 wherein the predicted future occurrence of the query term from each of the models is weighted prior to averaging the predictions.

13. The system of claim 10 wherein the traditional model is configured to use auto regression.

14. The system of claim 10 wherein the periodicity model is configured to use a cosine signal hidden periodicity model.

15. The system of claim 10 wherein the correlation model is configured to identify related queries to the query term and to use those related queries in determining the frequency of future occurrence of the query term.

16. The system of claim 11 wherein the unified model is configured to use a moving average over a time series to determine the future occurrence of the query term.

17. The system of claim 9 wherein the frequency prediction component is configured to obtain data from a service indicative of previous frequencies of occurrence of the at least one query term.

18. The system of claim 9 wherein the hotness detection component is configured to identify query terms that exceed a predetermined threshold value for the future occurrence; and to store those identified query terms.

19. A computer readable media having computer executable instructions that when executed cause a computer to:
receive a data log of queries having at least one query term from a service;
analyze the data log to determine a relative historic frequency of the at least one of query term;
predict a future frequency of the at least one query term by processing the query term through a unified model that averages prediction results from a traditional model, a periodicity model and a correlation model; and
storing the at least one query term when the predicted future frequency exceeds a threshold value.
